(19) United States
(12) Patent Application Publication
(10) Pub. No.: US 2023/0058427 A1
(43) Pub. Date: Feb. 23, 2023

(54) WIRELESS HEADSET WITH HEARABLE FUNCTIONS

(71) Applicant: HUAWEI TECHNOLOGIES CO., LTD., Shenzhen, Guangdong (CN)

(72) Inventors: Jyri PAKARINEN, Helsinki (FI); Tommi RAUSSI, Kista (SE); Laura LAAKSONEN, Helsinki (FI); Markus VAALGAMAA, Helsinki (FI); Jari SJÖBERG, Tampere (FI); Lisheng TIAN, Shanghai (CN)

(21) Appl. No.: 17/796,910

(22) PCT Filed: Feb. 3, 2020
(86) PCT No.: PCT/EP2020/052597

§ 371 Date: Aug. 2, 2022

(51) Int. Cl. G10K 11/178; H04R 1/10; H04R 1/40; H04R 3/00; G06F 3/16

(52) U.S. Cl. CPC G10K 11/17837; H04R 1/1016; H04R 1/1041; H04R 1/1083; H04R 1/406; H04R 3/005; G06F 3/165; G10K 11/17881; G10K 11/17823; G10K 11/17827; G10K 11/17825; H04R 2460/01; G10K 2210/1081; H04R 2420/07; H04R 2430/01; G10K 2210/3056; G10K 2210/3027; G10K 2210/3044; G10K 2210/3026

(57) ABSTRACT

A system for adjusting volume and ambient sounds in an earphone device with Active Noise Cancelling (ANC) functionality, implemented using a microphone and a signal processor, wherein a signal mixer is configured to, in response to detecting a rotation of a first dial connected to the earphone device, adjust the proportions between a group of signals in a mixed signal generated for the speaker of the earphone device, and thereby enabling precise and intuitive control of both playback volume and ambient sound processing.

### CROSS-REFERENCE TO RELATED APPLICATIONS

This application is a national stage of International Application No. PCT/EP2020/052597, filed on Feb. 3, 2020, which is hereby incorporated by reference in its entirety.

### TECHNICAL FIELD

The disclosure relates in general to the technical field of personal listening audio devices such as earphones, headphones and headsets, and in particular to controlling playback volume and ambient sound processing in true wireless stereo (TWS) headsets.

### BACKGROUND

With increased popularity of portable media players and mobile phones in recent years, the use of earphones has become commonplace. In the following disclosure, the term “earphones” will be used to refer to over-the-ear headphones as well as in-ear earphones or earbuds.

When using earphones, whether to listen to music, other audio files, or conducting a phone conversation, finding an appropriate volume level to listen at is crucial. Too soft of a volume and it may not be possible to easily hear the sound coming from the earphones. Too loud of a volume can damage the user's ears, and thus overly-loud volumes should be avoided as much as possible. Ambient noise coming from the external environment can also be very loud in many circumstances and can further add to the problem, often compensated by earphone users by further increasing the sound volume level coming from the earphones, resulting in increased potential damage to the user's ears, especially during long-term usage.

To provide a form of passive barrier against ambient noise, earphones are often designed to form some level of acoustic seal with the ear of the wearer. In the case of in-ear type earbuds, silicone or foam tips of different sizes can be used to improve the fit within the ear and also improve passive noise isolation. However, in many cases such acoustic seal is undesirable, and can even prove to be dangerous by blocking alerting sounds (such as an approaching vehicle) from the environment. In such a case, an active noise cancellation (ANC) mechanism may be effective to reduce the background noise and thereby improve the user's experience. ANC is a technique that aims to “cancel” unwanted noise, by introducing an additional, electronically controlled sound field referred to as anti-noise. The anti-noise is electronically designed so as to have the proper pressure amplitude and phase that destructively interferes with the unwanted noise or disturbance. An error sensor (typically an acoustic microphone) is provided in the earphone housing to detect the so-called residual or error noise. The output of the error microphone is used by a control system to adjust how the anti-noise is produced, so as to reduce the ambient noise that is being heard by the user of the earphone.

However, ambient noises are variable, for example some ambient noises might be useful or even essential for a user to hear to certain degrees while listening to, e.g., music or conducting a conversation on an earphone device. The problem with most existing noise-reducing earphones today is that they only provide ANC activation and deactivation functions for the user to accommodate to different ambient noises. For example, in an environment such as an ordinary office, when the usual ANC function of an earphone is directly activated to reduce noises by more than 25 dB, the user could feel like being in an uncomfortably anechoic room. In another environment, such as when walking on a street amongst dangerous traffic conditions, the ANC function may block alerting sounds that may prove dangerous. Some ambient noises, such as speech directed to the user, would even be useful to be enhanced in comparison to other ambient noises. Thus, the user would not want to simply turn on or off the ANC function, but rather set a desirable rate of ambient noise attenuation or enhancement by the earphone device.

In addition, controlling the type of wireless earphones that are becoming more and more popular and even essential with the introduction of smartphones that lack any physical wired connection possibilities, such as true wireless stereo (TWS) headsets, is increasingly problematic due to their small physical size. On the one hand, the user should be able to control important features (such as playback volume, or volume of ambient sounds) on the headset directly. On the other hand, current button-based or capacitive touch-based controls are confusing and unsatisfactory due to the small size of the units and the fact that the user cannot see the controls when wearing the headset. In particular, existing earphone (e.g. TWS headset) control solutions use either push buttons (confusing to user if multiple buttons per device are to be used due to small size), touch controls (capacitive and other similar technologies do not have sufficient accuracy for problem-free use), or companion smartphone apps (need to operate smartphone to use the headset).

### SUMMARY

It is an object therefore to provide an improved system for adjusting ambient sounds in an earphone device which overcomes or at least reduces the problems mentioned above—specifically that existing earphones with noise-reducing function are functionally monotonic in terms of noise reduction (i.e. the noise reduction function thereof can only be either activated or deactivated).

The foregoing and other objects are achieved by the features of the independent claims. Further implementation forms are apparent from the dependent claims, the description and the figures.

According to a first aspect, there is provided a system comprising:

at least one microphone configured to generate at least one microphone signal;

a signal processor configured to generate an Active Noise Cancellation, ANC, signal based on the at least one microphone signal;

a signal mixer configured to mix a group of signals to generate a mixed signal, the group of signals comprising the ANC signal and at least one microphone signal;

a speaker configured to generate sound waves based on the mixed signal; and

a rotatable first dial; wherein

the signal mixer is further configured, in response to detecting a rotation of the first dial, adjust the proportions between the group of signals in the mixed signal.

Using a rotatable dial (such as the ubiquitous volume knob) in TWS units for controlling the playback volume and ambient sound processing aspects gives the user of the system an improved way to control the playback volume compared to existing TWS implementations, and an intuitive way to control the ambient sound processing, without the need for implementing complex hardware solutions.

In one embodiment, the signal processor is further configured to process the at least one microphone signal, before it is sent to the signal mixer, to match the sound characteristics of an unblocked ear canal, thereby enabling a natural hear-through effect.

In a possible implementation of the first aspect, the signal processor is further configured to process the at least one microphone signal from the at least one microphone and generate an enhanced microphone signal by applying at least one of noise suppression, optionally followed by raising the overall volume; speech enhancement; signal alteration based on preset sonic characteristics, such as equalization; signal alteration based on directional characteristics of the sound field surrounding the at least one microphone; signal alteration based on an estimated usage environment of the system, for example in an airplane, office or outdoors; or signal alteration based on an estimated usage mode of the system, for example discussion, exercise, or work; wherein the group of signals further comprises the enhanced microphone signal.

In a further possible implementation of the first aspect, the first dial is rotatable between a first state, a second state, and a third state, and the signal mixer is configured to:

in response to detecting the first dial being in the first state, increase the proportion of the ANC signal to a maximum,

in response to detecting the first dial being in the second state, increase the proportion of the microphone signal to a maximum, and

in response to detecting the first dial being in the third state, increase the proportion of the enhanced microphone signal to a maximum, and to iterate signal proportions in response to detecting a rotation of the first dial between the first state, second state, and third state.

In a further possible implementation of the first aspect, the rotation of the first dial is limited between a first extreme position and a second extreme position, wherein

reaching the first extreme positions sets the first dial in the first state,

reaching the second extreme position sets the first dial in the third state, and

a predefined intermediary position between the first extreme position and the second extreme position sets the first dial in the second state.

In a further possible implementation of the first aspect, the first dial is configured to be freely rotating, wherein

passing a first position in a first rotational direction sets the first dial in the first state,

passing a second position in a second rotational direction sets the first dial in the third state, and

a predefined intermediary position between the first position and the second position sets the first dial in the second state.

In a further possible implementation of the first aspect, the system further comprises:

at least one of a storage medium or a communication interface; and

a program unit configured to generate a program signal based on at least one of

a program file stored on the storage medium,

a program code for locally synthesizing a program signal, or

a program stream received using the communication interface;

wherein the signal mixer is further configured to mix the program signal into the mixed signal.

This enables, e.g., an earphone device to play a sound to a user while still providing means for the user to hear ambient noises in a natural, enhanced or attenuated manner, or even set the earphone to full noise cancelling mode and only listen to an audio program.

In a further possible implementation of the first aspect, the system comprises a rotatable second dial; wherein the signal mixer is further configured, in response to detecting a rotation of the second dial, adjust the volume of the program signal with respect to the remaining signals in the mixed signal.

This enables separate control of the program volume with respect to all other signals in the mix.

In a further possible implementation of the first aspect, the system comprises:

an earphone device comprising a housing configured to fit into an ear canal or to substantially cover the opening of an ear canal;

the housing comprising a first side, and a second side opposite to the first side;

wherein the at least one microphone is arranged in the housing facing outwards from the first side and configured to capture sound waves from the external environment;

wherein the speaker is arranged in the housing facing outwards from the second side and configured to generate sound waves for delivery towards the inside of the ear canal; and wherein one of the first dial or the second dial is rotatably mounted on the first side.

In a further possible implementation of the first aspect, the earphone device comprises at least two microphones arranged in the housing facing outwards from the first side and configured to be oriented towards the mouth of a user of the earphone device to enable acoustic beamforming.

In a further possible implementation of the first aspect, the system comprises:

at least one earphone device according to possible implementation forms of the first aspect as described before; and

a host device arranged in data connection with the at least one earphone device; wherein the host device comprises the signal processor, the signal mixer, the program unit and the at least one of the storage medium or the communication interface.

In this embodiment, the earphone device can be implemented without own storage and processing means, resulting in a simpler construction that enables a small size and lighter weight, which are of high importance in the case of TINS headsets.

In a further possible implementation of the first aspect, the host device is a mobile smartphone and the data connection is established using a Bluetooth protocol.

In a further possible implementation of the first aspect, the earphone device further comprises the signal processor, the signal mixer, the program unit and the at least one of the storage medium or the communication interface, and thereby forms an integrated and independent earphone unit that is able to function without further devices (such as a host device).

In a further possible implementation of the first aspect, the system comprises:

a first earphone device according to possible implementations of the first aspect as described before, comprising a rotatable first dial; and

a second earphone device according to possible implementations of the first aspect as described before, comprising a rotatable second dial;

wherein the signal mixer is configured to:

in response to detecting a rotation of the first dial, adjust the volume of the program signal with respect to the remaining signals in the mixed signal, and in response to detecting a rotation of the second dial, adjust the proportions between the ANC signal, the microphone signal and the enhanced microphone signal in the mixed signal.

This enables the use of a dual rotating dial in a true wireless stereo headset (one dial in left unit, another one in right unit) device for controlling both the playback volume of a program material as well as ambient sound processing (e.g. active noise cancellation, hear-through volume of direction).

In a further possible implementation of the first aspect, the first dial further comprises a push button functionality; and the signal mixer is further configured to:

in response to detecting a button push of the first dial, adjust the proportions between the group of signals in the mixed signal to match a predefined setting.

In a further possible implementation of the first aspect, the second dial further comprises a push button functionality; and the program unit is further configured to:

in response to detecting a button push of the second dial, execute a predefined function, such as play or pause, of the program signal.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 shows a block diagram of a system in accordance with one embodiment of the first aspect;

FIG. 2 shows a timeline diagram illustrating the functioning of a system in accordance with another embodiment of the first aspect;

FIG. 3 shows a side view of a dial as part of a system in accordance with another embodiment of the first aspect;

FIG. 4 shows a block diagram of a system in accordance with another embodiment of the first aspect;

FIG. 5 shows a cross-section of an earphone device as part of a system in accordance with another embodiment of the first aspect;

FIG. 6 shows a side view of a system comprising two earphone devices in accordance with another embodiment of the first aspect;

FIG. 7 shows a block diagram of a system in accordance with another embodiment of the first aspect; and

FIG. 8 shows a block diagram of a system in accordance with another embodiment of the first aspect.

### DETAILED DESCRIPTION

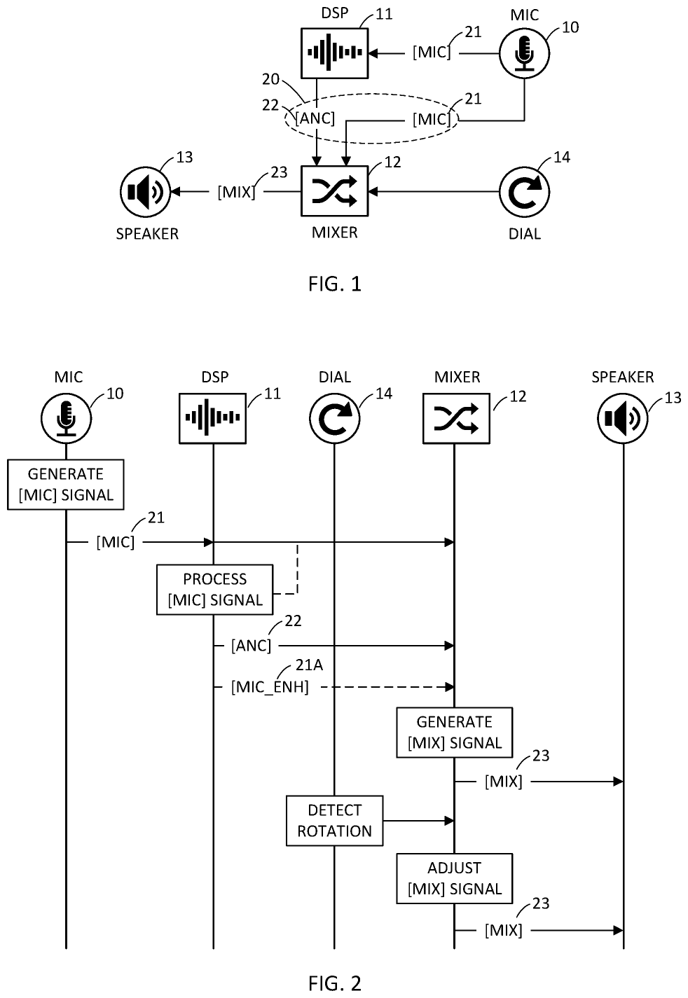

FIG. 1 illustrates a system according to the present disclosure. The system comprises one or more microphone(s) 10, each configured to generate a microphone signal 21; and a signal processor 11 configured to generate an Active Noise Cancellation (ANC) signal 22 based on the microphone signal(s) 21.

ANC is a technology designed to cancel out unwanted ambient noise by introducing an additional, electronically controlled sound field referred to as anti-noise. The anti-noise is electronically designed so as to have the proper pressure amplitude and phase that destructively interferes with the unwanted noise or disturbance. An error sensor (in the present case a microphone 10) is provided in the system to detect the so-called residual or error noise. The microphone signal 21 of the microphone 10 is used by the signal processor 11 to produce the ANC signal 22 so as to ultimately reduce the ambient noise that is being heard by the user 6 of an earphone 1 (by mixing the ANC signal 22 in the output mixed signal 23).

The system further comprises a signal mixer 12 configured to mix a group of signals 20 to generate a mixed signal 23, the group of signals 20 comprising the ANC signal 22 and at least one microphone signal 21. This way the ANC signal 22 can be used to ultimately reduce the ambient noise that is being heard by the user 6 of an earphone 1 to a certain extent, by mixing the ANC signal 22 in with the original microphone signal 21 (and further signals, as explained below) in the output mixed signal 23.

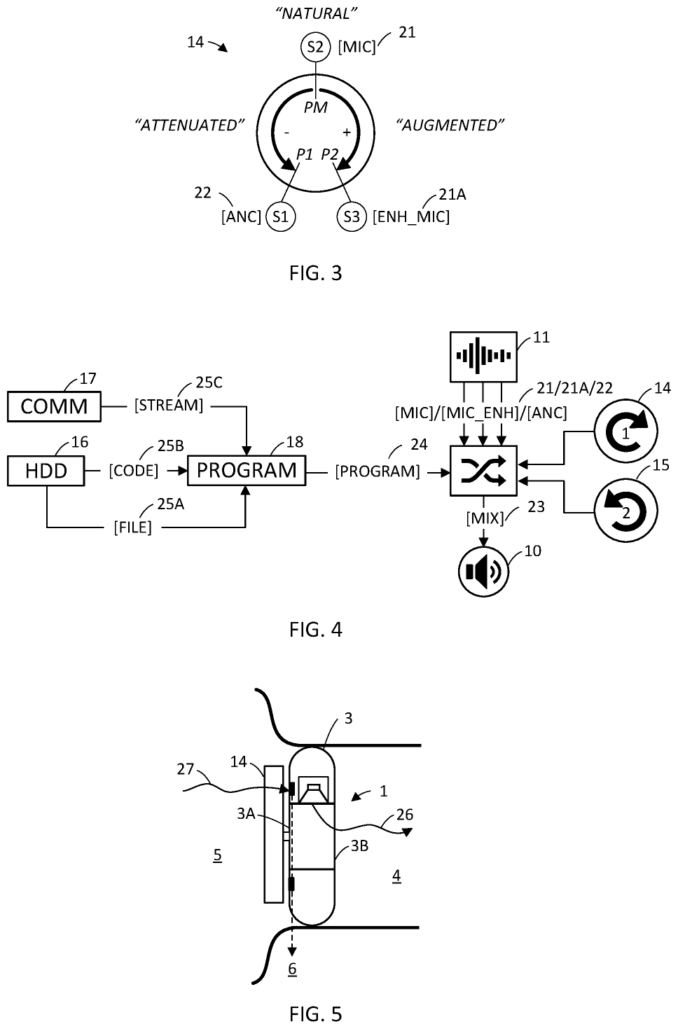

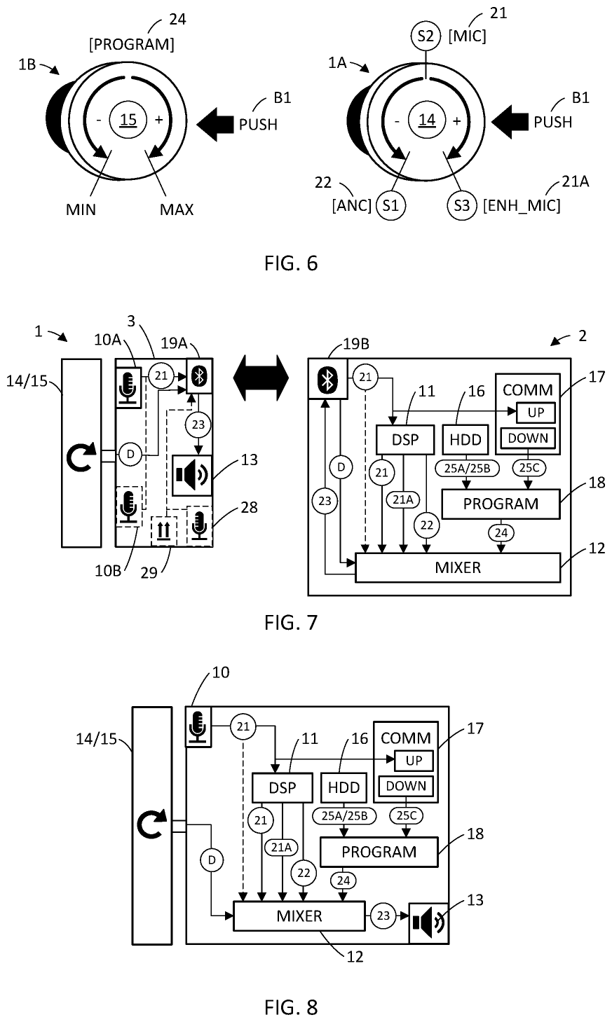

The system also comprises at least one speaker 13 configured to generate sound waves 26 based on the mixed signal 23; as well as a rotatable first dial 14, such as a conventional volume adjustment dial that is generally implemented in audio devices. The first dial 14 can be an infinitely rotatable dial or a limited rotation dial, as will be explained below with respect to FIG. 3. In an example embodiment, the system comprises two speakers 13, each arranged in a respective earphone device 1A,1B for a left and right ear of a user 6 (as will be explained below in more detail, see FIGS. 6-8), and configured to generate sound based on the same mixed signal 23.

In an embodiment, the signal mixer 12 is configured to, in response to detecting a rotation of the first dial 14, adjust the proportions between the group of signals 20 in the mixed signal 23, and thus enable precise control over enhancement or attenuation of the ambient noise in the output sound waves 26 generated by the speaker 13 that eventually reach the ear of the user 6.

FIG. 2 shows a timeline diagram illustrating the functioning of a system in accordance with the present disclosure, wherein a microphone signal 21 is generated, based on captured sound waves from the environment 5, by the microphone 10 and is sent either directly to the signal mixer 12 or to the signal processor 11 to be processed. The signal processor 11 then generates an Active Noise Cancellation (ANC) signal 22 based on the microphone signal(s) 21 and sends the ANC signal 22 to the signal mixer 12.

In an embodiment, the signal processor 11 is further configured to process the microphone signal 21, before it is sent to the signal mixer 12, to match the sound characteristics of an unblocked ear canal 4, in order to create the illusion of an open ear canal 4 for the user 6, thereby helping in decreasing or eliminating the occlusion effect that is common when using in-ear type earphones.

In an embodiment, the signal processor 11 is further configured to process the at least one microphone signal 21 from the at least one microphone 10 and generate an enhanced microphone signal 21A, which is then sent to the signal mixer 12 as part of the group of signals 20. The enhanced microphone signal 21A can be generated in multiple ways, according to the desired ambient sound enhancement goal. In one example, noise suppression can be applied to the microphone signal(s) 21, optionally followed by raising the overall volume, to achieve better Signal-to-Noise Ratio (SNR). In a further example, speech enhancement can be applied using, e.g., conventional machine learning algorithms. The microphone signal 21 can also be altered based on either pre-set sonic characteristics (such as equalization), based on directional characteristics of the sound field surrounding the at least one microphone 10, or based on an estimated usage environment of the system (for example, in an airplane, office or outdoors), or based on an estimated usage mode of the system (for example, discussion, exercise, or work).

As described above, the signal mixer 12 can then mix the group of signals 20 to generate the mixed signal 23, which is sent to the speaker 13 to generate sound waves 26 based on the mixed signal 23. If the signal mixer 12 detects a rotation of the first dial 14, it can adjust the proportions between the group of signals 20 in the mixed signal 23 based on the rotation of the first dial 14, as will be explained in detail below.

FIG. 3 shows a side view of a first dial 14 in accordance with the present disclosure, illustrating how the rotation of the first dial 14 influences the adjustment of the proportions of the group of signals 20 in the mixed signal 23. In the illustrated embodiment, the first dial 14 is rotatable between a first state S1, a second state S2, and a third state S3. In response to rotation of the first dial 14, the signal mixer 12 is configured to adjust proportions between the group of signals 20 in the mixed signal 23 as follows:
in response to detecting the first dial 14 being in the first state S1, increase the proportion of the ANC signal 22 to a maximum,
in response to detecting the first dial 14 being in the second state S2, increase the proportion of the microphone signal 21 to a maximum, and
in response to detecting the first dial 14 being in the third state S3, increase the proportion of the enhanced microphone signal 21A to a maximum.

The signal mixer 12 can further be configured to iterate signal proportions in response to detecting a rotation of the first dial 14 between the first state S1, second state S2, and third state S3. This iteration can for example be linear but also logarithmic, the latter being more suited for human control. It is to be noted that the illustrated embodiment is just an example, and an embodiment where state S3 is linked with maximum ANC signal 22 and state S1 is linked with maximum enhanced microphone signal 21A is similarly feasible, as well as any further possible combinations of states and signal maximalizations.

In an embodiment, the rotation of the first dial 14 is limited between a first extreme position P1 and a second extreme position P2, wherein reaching the first extreme position P1 sets the first dial 14 in the first state S1, reaching the second extreme position P2 sets the first dial 14 in the third state S3, and a predefined intermediary position PM between the first extreme position P1 and the second extreme position P2 sets the first dial 14 in the second state S2.

In an alternative embodiment, the first dial 14 is configured to be freely rotating, wherein passing a first position in a first rotational direction sets the first dial 14 in the first state S1, passing a second position in a second rotational direction sets the first dial 14 in the third state S3, and a predefined intermediary position PM between the first position and the second position sets the first dial 14 in the second state S2.

FIG. 4 shows a block diagram of a system in accordance with the present disclosure illustrating an embodiment where the group of signals 20 to be mixed in the mixed signal 23 further comprises a program signal 24 (such as music or other audio program), enabling, e.g., an earphone device 1 to play a sound to a user 6 while still providing means for the user to hear ambient noises in a natural, enhanced or attenuated manner, or even set the earphone 1 to full noise cancelling mode and only listen to an audio program. In this embodiment, the system comprises a storage medium 16 and/or a communication interface 17; and a program unit 18. The program unit 18 is configured to generate the program signal 24 based on at least one of
a program file 25A stored on the storage medium 16 (such as an audio file stored in, e.g., MP3 format),
a program code 25B for locally synthesizing a program signal 24, or
a program stream 25C received using the communication interface 17 (from, e.g., a server of a music streaming service provider).

As shown in the figure, in an embodiment, the system can further comprise a rotatable second dial 15; and the signal mixer 12 may further be configured, in response to detecting a rotation of the second dial 15, adjust the volume of the program signal 24 with respect to the remaining signals in the mixed signal 23. This enables separate control of the program volume with respect to all other signals in the mix.

FIG. 5 shows a cross-section of an earphone device 1 as part of a system implemented in accordance with the present disclosure. In the illustrated embodiment the earphone device 1 comprises a housing 3 configured to fit into an ear canal 4 or to substantially cover the opening of an ear canal 4 of a user 6, wherein the housing 3 comprises a first side 3A, and a second side 3B opposite to the first side 3A. At least one microphone 10 is arranged in the housing 3 facing outwards from the first side 3A and configured to capture sound waves 27 from the external environment 5; and a speaker 13 is arranged in the housing 3 facing outwards from the second side 3B and configured to generate sound waves 26 for delivery towards the inside of the ear canal 4 of a user 6. The speaker may comprise a front cavity and a back cavity isolated from the front cavity for optimal sound wave generation. One of the first dial 14 or the second dial 15 is rotatably mounted on the first side 3A for adjusting the proportions between the group of signals 20 in the mixed signal 23, as described before.

In an embodiment, the earphone device 1 comprises at least two microphones 10A, 10B arranged in the housing 3 facing outwards from the first side 3A and configured to be oriented towards the mouth of a user 6 of the earphone device 1 to enable acoustic beamforming (see also the arrangement in. FIG. 7).

FIG. 6 shows a side view of a system comprising two earphone devices 1A and 1B in accordance with a further embodiment, which may correspond to an implementation of a TWS earphone system configured to be used in a left and right ear of a user 6 respectively. Steps and features that are the same or similar to corresponding steps and features previously described or shown herein are denoted by the same reference numeral as previously used for simplicity. In this embodiment, a first earphone device 1A comprises a rotatable first dial 14 as described above, and a second earphone device 1B comprises a rotatable second dial 15 as also described above. The signal mixer 12 is configured to, in response to detecting a rotation of the first dial 14, adjust the volume of the program signal 24 with respect to the remaining signals in the mixed signal 23, whereby in response to detecting a rotation of the second dial 15, it is configured to adjust the proportions between the ANC signal 22, the microphone signal 21 and the enhanced microphone signal 21A in the mixed signal 23.

In further possible embodiments, either or both of the first dial 14 and the second dial 15 may be configured with a push button functionality. Accordingly, in an embodiment, the first dial 14 further may comprise a push button functionality B1; wherein the signal mixer 12 can be configured to, in response to detecting a button push B1 of the first dial 14, adjust the proportions between the group of signals 20 in the mixed signal 23 to match a predefined setting, such as maximizing the ANC signal 22 for maximal ambient noise cancellation, maximizing the hear-through signal for simulating an unblocked ear canal, or maximizing the enhanced microphone signal 21A for conducting a conversation. In an embodiment, the second dial 15 can comprise a push button functionality B2; wherein the program unit 18 can be configured to, in response to detecting a button push B2 of the second dial 15, execute a predefined function of the program signal 24, such as playing or pausing.

In a further alternative embodiment, the above described functionalities of the first dial 14 and the second dial 15 can be implemented in a single dial unit, and can be switched between a “first dial mode” and a “second dial mode” using a push button functionality B.

The earphones 1A and 1B may further comprise compressible eartips for secure location in the ear canal 4.

FIGS. 7 and 8 show block diagrams of alternative embodiments of the system in accordance with the present disclosure. Steps and features that are the same or similar to corresponding steps and features previously described or shown herein are denoted by the same reference numeral as previously used for simplicity.

According to the embodiment illustrated in FIG. 7, the system comprises an earphone device 1 as described above, and a host device 2 arranged in data connection with the at least one earphone device 1 using respective Bluetooth interfaces 19A, 19B implemented in the respective devices. In this embodiment, the host device 2 comprises the signal processor 11, the signal mixer 12, the program unit 18 and the at least one of the storage medium 16 or the communication interface 17, whereas the earphone device 1 includes at least one microphone 10 (preferably a first microphone 10A and a second microphone 10B configured to be oriented towards the mouth of a user 6 of the earphone device 1 to enable acoustic beamforming), a speaker 13 and a first dial 14 or a second dial 15 arranged on one side. In this embodiment, the earphone device can be implemented without own storage and processing means, resulting in a simpler construction that enables a small size and lighter weight, which are of high importance in the case of TINS headsets. The host device 2 may be a mobile smartphone and the data connection may, e.g., be established using a Bluetooth or Bluetooth Low Energy (BLE) protocol. The microphone signal 21 from the microphone(s) 10 (10A,10B), as well as any further input signals (such as a dial signal D indicating a rotational direction and an extent of the first dial 14 or the second dial 15) are communicated using the Bluetooth interface 19A to the Bluetooth interface 19B of the host device. From there, the signals are sent to the respective units within the host device 2, such as the signal processor 11 or the signal mixer 12, as explained above. The microphone signal 21 can also be sent, in case of, e.g., a phone call, to an uplink unit of the communication interface 17, for forwarding it to a receptive unit via a mobile or a wireless computer network. The downlink unit of the communication interface 17 can be used for streaming a program stream 25C as input for the program unit 18. In return, the mixed signal 23 generated by the signal mixer 12 (as explained above in detail) can be communicated via the respective Bluetooth interfaces 19B and 19A to the earphone device 1, where it is sent to the speaker 13 for generating sound waves 26.

In further embodiments, the earphone device 1 may also include an internal microphone 28 arranged in the housing 3 facing outwards from the second side 3B and configured to capture sound waves from the direction of the ear canal 4 and to generate an internal microphone signal; and/or a voice accelerometer 29 configured to detect presence of the voice of the user 6 of the earphone device 1 via vibrations and generate an own voice signal. These additional signals can be used as further inputs in the signal processor 11 or the signal mixer 12.

According to the embodiment illustrated in FIG. 8, the earphone device 1 comprises all the essential components of the system as described above in detail, such as the microphone(s) 10, the first dial 14 or second dial 15, and the speaker 13, further including the signal processor 11, the signal mixer 12, the program unit 18 and the at least one of the storage medium 16 or the communication interface 17, and thereby forms an integrated and independent earphone unit that is able to function without further devices (such as a host device 2 as explained above).

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A system comprising:
at least one microphone configured to generate at least one microphone signal;
a signal processor configured to generate an Active Noise Cancellation (ANC) signal based on said at least one microphone signal;
a signal mixer configured to mix a group of signals to generate a mixed signal, the group of signals comprising the ANC signal and at least one microphone signal;
a speaker configured to generate sound waves based on the mixed signal; and
a rotatable first dial; wherein
the signal mixer is further configured to, in response to detecting a rotation of said first dial, adjust proportions between said group of signals in the mixed signal.

2. The system according to claim 1, wherein said signal processor is further configured to process said at least one microphone signal, before it is sent to the signal mixer, to match sound characteristics of an unblocked ear canal.

3. The system according to claim 1, wherein the signal processor is further configured to process the at least one microphone signal from said at least one microphone and generate an enhanced microphone signal by applying at least one of
noise suppression, optionally followed by raising an overall volume;
speech enhancement;
signal alteration based on preset sonic characteristics including equalization;
signal alteration based on directional characteristics of a sound field surrounding the at least one microphone;
signal alteration based on an estimated usage environment of the system the estimated usage environment comprising an airplane, office or outdoors; or
signal alteration based on an estimated usage mode of the system the estimated usage mode comprising discussion, exercise, or work,
wherein said group of signals further comprises said enhanced microphone signal.

4. The system according to claim 3, wherein
said first dial is rotatable between a first state, a second state, and a third state, and wherein
the signal mixer is configured to:
in response to detecting said first dial being in said first state, increase a proportion of said ANC signal to a maximum,
in response to detecting said first dial being in said second state, increase the proportion of said microphone signal to a maximum,
in response to detecting said first dial being in said third state, increase the proportion of said enhanced microphone signal to a maximum, and
iterate signal proportions in response to detecting a rotation of said first dial between said first state, said second state, and said third state.

5. The system according to claim 4, wherein
the rotation of said first dial is limited between a first end position and a second end position, wherein
reaching said first end position sets the first dial in said first state,
reaching said second end position sets the first dial in said third state, and
a predefined intermediary position between said first end position and said second end position sets the first dial in said second state.

6. The system according to claim 4, wherein
said first dial is configured to be freely rotating, wherein
passing a first position in a first rotational direction sets the first dial in said first state,
passing a second position in a second rotational direction sets the first dial in said third state, and
a predefined intermediary position between said first position and said second position sets the first dial in said second state.

7. The system according to claim 3, the system further comprising:
at least one of a storage medium or a communication interface; and
a program unit configured to generate a program signal based on at least one of
a program file stored on the storage medium,
a program code for locally synthesizing a program signal, or
a program stream received using the communication interface;
wherein the signal mixer is further configured to mix said program signal into said mixed signal.

8. The system according to claim 7, wherein the system comprises:
a rotatable second dial; and wherein
the signal mixer is further configured, in response to detecting a rotation of said second dial, adjust the volume of said program signal with respect to the remaining signals in the mixed signal.

9. The system according to claim 7, the system further comprising:
an earphone device comprising a housing configured to fit into an ear canal or to substantially cover an opening of an ear canal;
the housing comprising a first side, and a second side opposite to the first side;
wherein said at least one microphone is arranged in the housing facing outwards from said first side and configured to capture sound waves from an external environment;
wherein said speaker is arranged in the housing facing outwards from said second side and configured to generate sound waves for delivery towards the inside of the ear canal; and wherein
one of said first dial or said second dial is rotatably mounted on the first side.

10. The system according to claim 9, wherein the earphone device comprises at least two microphones arranged in the housing facing outwards from said first side and configured to be oriented towards the mouth of a user of the earphone device to enable acoustic beamforming.

11. The system:
according to claim 9, further comprising:
a host device arranged in data connection with said earphone device; wherein
said host device comprises said signal processor, said signal mixer, said program unit and said at least one of said storage medium or said communication interface.

12. The system according to claim 11, wherein said host device is a mobile smartphone, and said data connection is established using a Bluetooth protocol.

13. (canceled)

14. The system according to claim 7, further comprising:
a first earphone device comprising a first housing configured to fit into an ear canal or to substantially cover an opening of an ear canal, the first housing comprising a first side, and a second side opposite to the first side, and a rotatable first dial; and
a second earphone device comprising a second housing configured to fit into an ear canal or to substantially cover an opening of an ear canal, the second housing comprising a first side, and a second side opposite to the first side, and a rotatable second dial;
wherein the signal mixer is configured to:
in response to detecting a rotation of said first dial, adjust the volume of the program signal with respect to the remaining signals in the mixed signal, and
in response to detecting a rotation of said second dial, adjust proportions between said ANC signal, said microphone signal and said enhanced microphone signal in the mixed signal.

15. The system according to claim 14, wherein
said first dial further comprises a push button functionality; and wherein
the signal mixer is further configured to:
in response to detecting a button push of said first dial, adjust proportions between said group of signals in the mixed signal to match a predefined setting.

16. The system according to claim 14, wherein
said second dial further comprises a push button functionality; and wherein
the program unit is further configured to:
in response to detecting a button push of said second dial, execute a predefined function, the predefined function comprising playing or pausing of said program signal.
